(19) United States
(12) Patent Application Publication
(10) Pub. No.: US 2015/0116071 A1
(43) Pub. Date: Apr. 30, 2015

(54) ENERGY SUPPLY DEVICE FOR EXPLOSION-PROOF ELECTRONIC FUNCTIONAL UNITS

(71) Applicant: ABB TECHNOLOGY AG, Zurich (CH)

(72) Inventors: Bernhard WUNSCH, Baden-Dattwil (CH); Rainer Kretschmann, Bad Oeynhausen (DE); Ralf Schäffer, Hille (DE); Thomas Keul, Freigericht (DE); Uwe Drofenik, Zurich (CH)

(73) Assignee: ABB TECHNOLOGY AG, Zurich (CH)

(21) Appl. No.: 14/523,524

(22) Filed: Oct. 24, 2014

(30) Foreign Application Priority Data
Oct. 24, 2013 (DE) 202013009502.4

(51) Int. Cl. H01F 27/28; H01F 27/24

(52) U.S. Cl. CPC H01F 27/2804; H01F 27/24; H01F 2027/2809
USPC 336/200

(57) ABSTRACT

An exemplary energy supply device for explosion-proof electronic functional units, in which the functional units are supplied from a high-frequency AC voltage that is individually output for each of the functional units via an inductor. In order to supply a multiplicity of functional units with little effort, the multi-level printed circuit board of each inductor can be covered with a flat board of magnetic material. The flat board being parallel to a plane of conductor tracks of the inductors.

### RELATED APPLICATION

This application claims priority under 35 U.S.C. §119 to German application 202013009502.4 filed in Germany on Oct. 24, 2013, the content of which is hereby incorporated by reference in its entirety.

### FIELD

The disclosure relates to an energy supply device for explosion-proof electronic functional units.

### BACKGROUND INFORMATION

Known energy supply devices are used in automation systems to supply components close to the process and communication devices assigned to said components.

EP 1014531 A2 discloses such an energy supply device in which the functional units are supplied from a high-frequency AC voltage which is individually output for each of the functional units via an inductor. It is described that the windings of the inductors are formed as substantially congruent conductor tracks of a multi-level printed circuit board which are connected to one another, as are known, in principle, from JP 62154609 A1. In addition, it is described that the specified inductance of the inductors is caused by means of ferrite cores which project through openings in the multi-level printed circuit board.

This arrangement raises several concerns. For one, the production expenditure for the multi-level printed circuit board is very high as a result of the multiplicity of recesses and the fact that they are each fitted with two ferrite core halves. Furthermore, in order to achieve the specified inductance of the inductors, a multi-level printed circuit board having at least six metallization planes is called for, whereas four metallization planes suffice for the remaining wiring. Finally, the area of the inductors inside the multi-level printed circuit board limits the number of functional units which can be connected.

The German utility model DE 20 2013 008 747 U1 discloses the practice of forming the inductors as substantially congruent conductor tracks of a multi-level printed circuit board which are connected to one another and arranging them vertically on a distribution printed circuit board, the number of metallization planes of the multi-level printed circuit board being greater than the number of metallization planes of the distribution printed circuit board. However, with a high packing density, the inductors in the form of air-core coils influence one another.

### SUMMARY

An exemplary energy supply device for explosion-proof electronic functional units is disclosed, in which the functional units are supplied from a high-frequency AC voltage which is individually output for each of the functional units, the device comprising: a plurality of inductors, each inductor is connected to provide the AC voltage to a respective functional unit, and is formed of congruent conductor tracks of a multi-level printed circuit board which is arranged vertically on a distribution printed circuit board, wherein the multilevel printed circuit boards of the plurality of inductors are connected to one another, and wherein the multi-level printed circuit board of each inductor is covered with a flat board of a magnetic material parallel to a plane of the conductor tracks.

### DESCRIPTION OF THE DRAWINGS

Exemplary embodiments of the present disclosure are explained in greater detail with respect to the drawings provided as follows:

FIG. 1 illustrates an energy supply device for explosion-proof electronic functional units in accordance with an exemplary embodiment of the present disclosure.

### DETAILED DESCRIPTION

Exemplary embodiments of the present disclosure overcome the disadvantages of the known systems and specify an energy supply device for explosion-proof electronic functional units, which energy supply device supplies AC voltage and can supply a multiplicity of functional units with little effort.

Exemplary embodiments disclosed herein are based on an energy supply device for explosion-proof electronic functional units, in which the functional units are supplied from a high-frequency AC voltage which is individually output for each of the functional units via an inductor which is in the form of a multi-level printed circuit board and is arranged vertically on a distribution printed circuit board.

According to an exemplary embodiment of the present disclosure, the multi-level printed circuit board of each inductor can be completely covered with a flat board of a magnetic material parallel to the plane of its conductor tracks. As a result, the magnetic field emanating from each inductor is shaped in the immediate vicinity of the inductor in such a manner that influence by adjacent inductors is largely avoided.

In addition, the board of magnetic material increases the inductance of the inductor for the same mechanical parameters.

The shaping of the magnetic field of the inductor can be managed without the device including mechanically complicated recesses in the multi-level printed circuit board.

According to an exemplary embodiment of the present disclosure, each inductor consists of (e.g., includes) two windings with an opposite winding sense (e.g., direction). As a result, the shaping of the magnetic field of the inductor is intensified.

Directly adjacent inductors have field-shaping boards made of magnetic material on both sides. As a result, the spatial extent of the magnetic field is limited to the vicinity around the respective inductor.

The inductors can be arranged on the distribution printed circuit board with a high packing density with negligible mutual influence, with the result that a larger number of inductors is accommodated on the same area of the distribution printed circuit board. Accordingly, more functional units can be connected to the distribution printed circuit board given the same dimensions.

Another advantage of this exemplary arrangement is the insensitivity of the inductance value to fracture or partial loss of the board. The minimum inductance of the inductor which is specified for explosion protection is therefore ensured with simple means.

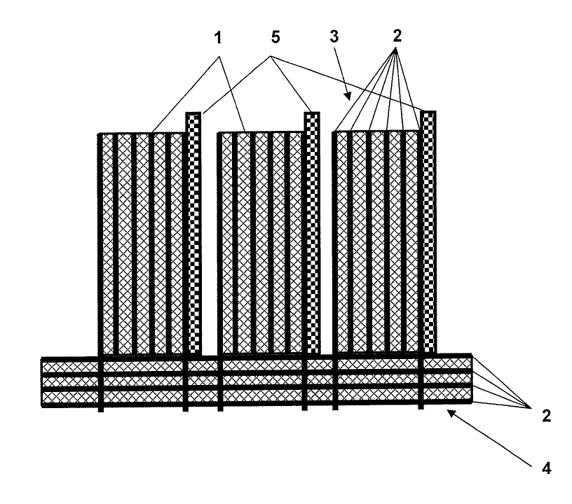

FIG. 1 illustrates an energy supply device for explosion-proof electronic functional units in accordance with an exemplary embodiment of the present disclosure. As shown in FIG. 1, the functional units are supplied from a high-frequency AC voltage which is individually output for each of the functional units via an inductor 1. A distribution printed circuit board 4 can have a plurality of inductors 1, with the inductors 1 being arranged vertically on the distribution printed circuit board 4.

The inductors 1 are in the form of substantially congruent conductor tracks 2 of a multi-level printed circuit board 3 which are connected to one another. In this case, each metallization plane of the multi-level printed circuit board 3 can have at least one turn of the inductor 1.

The inductors 1 are mechanically fastened and electrically contact-connected on the distribution printed circuit board 4. For this purpose, the distribution printed circuit board 4 can have a plurality of levels of conductor tracks 2.

The multi-level printed circuit board 3 of each inductor 1 is completely covered with a flat, field-shaping board 5 of a magnetic material parallel to the plane of its conductor tracks 2. The field-shaping board 5 can consists of (e.g., includes) a ferrite material. A field-shaping board 5 is therefore respectively arranged between two adjacent inductors 1.

As a result, the magnetic field emanating from each inductor 1 is shaped in the immediate vicinity of the inductor 1 in such a manner that influence by adjacent inductors 1 is largely avoided.

The field-shaping board 5 can be formed of magnetic material and increases the inductance of the inductor 1 for the same mechanical parameters.

According to another exemplary embodiment of the disclosure can provide for each inductor 1 to be equipped with two windings with an opposite winding sense. As a result, the shaping of the magnetic field of the inductor 1 is intensified.

According to yet another exemplary embodiment, the field-shaping boards 5 of magnetic material are adhesively bonded to the inductors 1.

According to another exemplary embodiment of the disclosure, the inductors 1 are surrounded by the field-shaping board 5 of magnetic material.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Inductor
2 Conductor track
3 Multi-level printed circuit board
4 Distribution printed circuit board
5 Field-shaping board

What is claimed is:

1. An energy supply device for explosion-proof electronic functional units in which the functional units are supplied from a high-frequency AC voltage which is individually output for each of the functional units, the device comprising:
a plurality of inductors, each inductor is connected to provide the AC voltage to a respective functional unit, and is formed of congruent conductor tracks of a multi-level printed circuit board which is arranged vertically on a distribution printed circuit board,
wherein the multilevel printed circuit boards of the plurality of inductors are connected to one another, and
wherein the multi-level printed circuit board of each inductor is covered with a flat board of a magnetic material parallel to a plane of the conductor tracks.

2. The energy supply device as claimed in claim 1, wherein each inductor includes two windings having an opposite winding sense.

3. The energy supply device as claimed in claim 1, wherein each flat board includes ferrite material.

4. The energy supply device as claimed in claim 1, wherein each flat board is arranged between two adjacent inductors.

5. The energy supply device as claimed in claim 1, wherein each flat board is adhesively bonded to a respective inductor.

6. The energy supply device as claimed in claim 1, wherein each inductor covered by the flat board of magnetic material is also surrounded by the flat board of magnetic material.
